(19) United States
(12) Patent Application Publication
(10) Pub. No.: US 2026/0294172 A1
(43) Pub. Date: Oct. 1, 2026

(54) AUTOMATIC-TYPE COFFEE GRINDER-DOSER APPLIANCE WITH WEIGHT CONTROL, WITH VIBRATION ABSORPTION

(71) Applicant: FIORENZATO M.C. S.R.L., Milano (MI) (IT)

(72) Inventor: Luca LISSANDRON, Vigodarzere (PD) (IT)

(21) Appl. No.: 19/490,066

(22) PCT Filed: Jun. 6, 2024
(86) PCT No.: PCT/IB2024/055536

§ 371 Date: Dec. 4, 2025

(30) Foreign Application Priority Data
Jun. 7, 2023 (IT) 102023000011565

(51) Int. Cl. A47J 42/40; A47J 42/44

(52) U.S. Cl. CPC A47J 42/40; A47J 42/44

(57) ABSTRACT

An automatic grinder-doser appliance with real time weight control, comprising a machine body with a shell and a base, grinding means driven by a motor, a dispenser, a support fork for a filter-holder cup, a load cell mounted on the base and connected to the fork, a logic unit that stops the drive at a preset value. The appliance has a first absorber device that isolates the cell from the base, with a mounting plate equipped with protrusions as point supports, a housing to fix the cantilevered cell and floating fixings to join the plate to the base by decoupling the elements and absorbing vibrations in each direction. The machine body is also equipped with a second absorber device, with opposing anti-vibration elements that prevent the transmission of shocks and vibrations to the base.

The present invention relates to an automatic-type grinder-doser appliance with weight control, with vibration absorption.

### FIELD OF APPLICATION

The invention finds particular, though not exclusive, application in the industrial sector of professional coffee bar equipment for the preparation of espresso coffee.

Generally speaking, professional espresso coffee preparation machines are widely known, which essentially have a body comprising a boiler that generates hot water and steam by delivering them to one or more dispensing groups in order to pass through a corresponding number of filter-holder cups containing ground coffee. Each filter, therefore, must first be filled with ground coffee powder in a specific machine that is designed to grind it and immediately dose it with precision, otherwise known as a grinder-doser appliance. In particular, the said filter-holder cup must be filled with the exact quantity of coffee powder, depending on the number of doses to be dispensed and the expected quality. Generally, in professional use, one or two doses are provided, each of a weight of approximately 7, 5 grams and 14 grams, so as to prepare one or two cups of espresso coffee of equal quality.

In a grinder-doser appliance, whole roasted coffee beans are generally collected in a cone-shaped container placed above the main body of the machine, where they enter by gravity into a grinding chamber comprising opposing grinders driven by an electric motor. The powder ground in this way is then ejected by means of dispensers that convey the coffee microgranules in such a way as to dose them and collect them correctly inside the said filter-holder cup positioned near the ejection opening, below the dispenser. In the professional field, manually or electronically controlled grinder-doser appliances are used; the former have a slide-type lever switch that basically leaves the user in control of how much and how to grind the coffee, while the latter are provided with various electronic control and/or detection systems to automatically manage the grinding and dispensing, and thus also the dosing. In practice, grinders of the electronic type have the advantage of limiting the operations to be performed by the operator who, sequentially, only has to position the cup corresponding to the desired dose and then select that dose, obtaining with good precision the desired weight, i.e. the set quantity of ground coffee powder.

In principle, modern grinder-dosers of the electronic type work according to two different types of operation: time-controlled otherwise called grind by time in English, or real time weight-controlled called grind by weight. In both cases, the desired quantity of coffee, relative to one or two doses, is initially set by the operator: in the first case, known as grind by time, the dose corresponds to a fixed grinding duration parameter, while in the second case, known as grind by weight, the dose corresponds to a fixed weight parameter, i.e. the quantity of powder actually dispensed expressed in grams, where the weight is progressively measured in real time so that the motor automatically stops when the set weight is reached, possibly considering a variable compensation share. From a technical point of view, therefore, a grinder of the grind by weight type must be provided with an automatic weighing device connected to the electronic control system of the device, with specific management programs.

The most advanced solutions of weight-controlled grinder-dosers provide for automatic weighing systems constructively and electronically integrated in the appliance in order to detect in real time, i.e. at the same time as the dispensing with the motor driven, the weight of the product actually dispensed so as to interrupt the drive when a preset value is reached. In particular, a detection device directly applied to the ground coffee container is known to progressively weigh the product as it leaves the dispenser together with its container. In this case, the weighing device can be configured as an external horizontal pan scale integrating individual strain gauges and/or a load cell connected to the control unit of the appliance, on which the container or cup with its supports is placed; see, by way of example only, document U.S. Pat. No. 6,783,089 (Lassota). The same technical effect can be achieved with a cantilevered support element acting as an arm lever to support and hold said container under the dispenser, on the outside of the appliance, with the opposite end on the inside where it is connected to a detection means, as mentioned, for example, in U.S. Pat. No. 5,386,944 (Knepler et al.).

The present invention relates to a modern electronic grinder-doser with real-time weight control, otherwise referred to as a grind by weight, which incorporates a weight detection means attached to the final container of the ground powder, such as an espresso filter-holder cup. In particular, an advantageous vibration-absorbing system is described in a weight detection system integrated inside the device, in a protected position, where a modern electronic load cell working in bending holds the cup at the front, suspended below the dispenser. In fact, it has been shown that such a weight detection system is fast, effective and can be easily and inexpensively integrated into modern direct ejection grinder powder dispensers, which are widely used and appreciated in professional use as they are structurally sound and reliable, constructively optimised, and at low costs.

In principle, modern electronic grinder-dosers of the grind-by-weight type including automatic weighing and control means have a compact design configuration, offer a high degree of user-friendliness, and achieve a high degree of precision in dispensing the desired dosage. They detect the quantity actually dispensed without taking into account the many variables that are otherwise involved in the grinding of roasted coffee, such as the type of coffee, roasting, humidity, temperature, set bean size or grindstone wear; consequently, in order to obtain the exact weight desired, with a real time weight control device the operator does not have to check and/or adjust the set parameters from time to time according to the above variables, as is required in conventional appliances where the duration of the grinding is set as a provisional value. It is therefore well known to operators in the field that modern grinder-dosers with real time weight control facilitate practical work and can improve the quality of the service offered. It has been found experimentally, however, that these grinder-dosers are very delicate and sometimes do not function well in such a way that weighing is unreliable, resulting in non-compliant weight doses.

In particular, the problems related to the high sensitivity of the integrated weighing medium are well known. In fact, in order to dynamically and accurately measure weight variations on small quantities of product with a high tare weight, as is the case with a normal grinder cup, it is necessary to integrate a very precise and sensitive sensor such as an electronic load cell with tenth of a gram accuracy. In practice, it has been seen that in grinder-dosers with an integrated load cell, the problem of disturbance caused by motor vibrations during grinding is not optimally solved to date by detecting the weight in real time. More in technical detail, the cell must progressively detect weight variations equal to fractions of a gram, while operating with the motor running and with grindstones rotating as they crush the beans; it follows that the powerful thrusts of the motor and grindstones can significantly alter the weighing. This happens more when vibrations are transmitted and/or amplified by the supporting structure of the appliance and the cell is mounted in such a way as to detect them.

Furthermore, in modern weight-controlled grinder-dosers there is the problem of frontally attaching a commonly used espresso machine filter-holder cup without damaging the weighing device. It has been found, in fact, that the aforementioned weighing precision can also be compromised by the shocks that the operator accidentally gives to the grinder-doser during the operation of hooking unhooking said filter-holder cup to the support fork, which is placed under the dispenser, said cup being generally made of metal with a high weight. In particular, such accidental shocks can distort the weighing device or even damage it irreversibly when the impact force exceeds the maximum load allowed by the cell, which is limited as it is extremely sensitive. Such an eventuality is therefore greater in appliances where the load cell is connected to the cup support fork, as is the case with the above-mentioned cantilever solutions. Additionally, it has been found that accidental shocks to the support surface or the body can also compromise the weighing result, resulting in non-compliant weight dispensing. In particular, it has been found that malfunctions caused by accidental shocks occur more frequently in bars and restaurants characterized by rushed use of the grinder-doser or in the case of inexperienced operators.

It has also been noted that in the aforementioned appliances with real time weight detection, any malfunctions caused by vibrations or a faulty cell are not apparent to the operator, who therefore unknowingly gives the customer poor quality espresso coffee. Merely by way of example, in the professional activity of a coffee bar, a tolerance of 0.2 grams or less in the actual weight dispensed compared to a nominal single dose of ground powder is generally considered acceptable. It has therefore been found experimentally that common vibrations and/or accidental shocks to the fork or the shell sometimes make the value measured by the cell unreliable.

In view of the above, the present invention offers a weight-controlled electronic coffee grinder-doser for professional use, of the improved type, capable of effectively preventing the aforementioned problems.

### State of the Art

In order to determine the state of the art relating to the proposed solution, a conventional patent literature search was carried out by querying public archives, which led to the identification of certain prior art, including:
D1 DE202016105762U1 (Mazzer)
D2 EP3019057 (Rego)
D3 EP3158902 (Dunkelberg et al.)
D4 U.S. Pat. No. 6,389,957B1 (Sham)
D5 EP1454574 (Diaz)
D6 EP3560400B1 (Parrini)
D7 EP3329811 (Abbiati)

In D1, a coffee grinder-doser appliance is described with a weighing device inserted in the machine body and a front support for positioning a common espresso cup below the front dispenser, wherein the front part of the support comprises the cup attachment fork and is removable, being fixed with magnets to the rear part connected to the internal load cell, so as to detach as a result of stresses excessive with respect to those tolerable by the cell.

D2 and D3 describe weighing devices for automatic coffee grinder-dosers, comprising a load cell operatively connected to a support for an espresso filter-holder cup, wherein the load cell is protected from shocks and overloads by excursion limiting means or end stops. For example, in D2 the load cell is connected to the cup holder fork by means of a composite elevation structure, where the outer walls slide vertically on internal elements designed to limit its extension, abutting at the upper end. In D3 the cell is inside a base aggregated to the front of the machine body, which integrates the cup support fork and places it under the dispenser, with a stroke limiter mounted under the bending end of the cell; this is made with an adjustable screw that passes through the bottom under the cell, with an external stop disc and a spacer sleeve in the hole so that the free end of the cell can flex vertically with a maximum controlled extension, protecting the cell from possible overload.

In D4, D5 and D6, damping support elements, made of a resilient and/or elastic material, are integrated to reduce vibrations in motor-driven grinders. For example, in D4 there is a horizontal-axis grinder with damping elements directly applied to the rotation support; in D5 a shop coffee grinder is described comprising a main body with a bean hopper below which is a grinding unit directly mounted on elastic, buffering supports, in the form of cylindrically shaped vibration-absorbing feet with a central shrinkage, which reduce the transmission of vibrations and noise during its operation; underneath them is in turn integrated a time-controlled dosing device which dispenses, on a corresponding receiver plate, a predetermined quantity of coffee. In D6, on the other hand, there is a coffee grinding system with a pair of interconnected and functionally matched automatic grinder-doser appliances, with an internal load cell, and with isolating feet mounted underneath the entire machine body; the feet are rubber disks and are provided with a threaded metal stem to screw into corresponding holes on the base.

D7 proposes a particular dosing device, for an automatic coffee grinder appliance, which has a main body with a conduit receiving ground coffee and discharging it by gravity into an external container, such as a filter-holder cup; said device has means for closing the conduit to allow the accumulation of ground coffee inside it and has its own weighing means for detecting its weight with a load cell of the bending type having one end connected to said main body to progressively detect the weight. A vibration-reducing design configuration is envisaged, whereby the load cell connected to the dosing device is fixed to a plate with a connecting flange spaced by means of damping elements.

### Drawbacks

Generally speaking, in automatic grinders of the grind-by-weight type, there is the problem of motor vibrations that disturb detection, being made together to the grinding, and also the problem of the tight tolerances of a modern weighing device with an integrated load cell that must dynamically and accurately detect weight variations relative to minimum quantities of product; generally speaking, these quantities are between 7 and 15 grams for single and double espresso doses respectively. Therefore, by integrating a very precise and sensitive weighing device inside the machine body, there is the dual problem of eliminating or limiting vibrations that may alter the quality of detection and also that of protecting it from accidental shocks or excessive loads, which may damage it. It has been seen that the above-mentioned known solutions are not sufficiently effective and cause certain disadvantages or unsolved problems.

First of all, it was observed that the aforementioned problems are addressed independently or non-contextually. For example, one intends to protect the cell from excessive shocks or loads, as in D1-D3, or one intends to reduce the vibration emission of the motor at its origin, as in D4, or to isolate the entire machine body from the work surface, as in D6. In practice, these solutions either protect the cell from damage or reduce the amount of overall appliance vibrations, but do not prevent the cell from receiving them, i.e. they do not isolate it locally, with the possibility of inaccurate detection and progressive cell calibration alteration.

Secondly, it has been seen that the solution referred to in D5 has the advantage of isolating the grinding means with a suspension effect, with respect to the structure of the machine body; however, it does not refer to a modern bar grinder with automatic weight control, which provides for a weighing means with high sensitivity structurally integrated into the machine body. Instead, this appliance solution can be combined with an independent and/or external weighing device, of the conventional type, with a weighing pan capable of detecting the weight of a container placed on it, as is the case, for example, in retail or infusion coffee. In fact, it does not allow the use of a standard filter-holder cup for espresso coffee machines, where a quick and frequent coupling and uncoupling to a support fork attached to the front of the machine is required. In such cases, in fact, a structural configuration where the weighing means is integrated into the appliance and attached to the aforementioned fork is preferred, with greater problems of shocks and vibration.

Thirdly, it has been found that the known load cell damping solution referred to in D7 relates to an appliance functionally different relative to the present invention, as the cell detects the weight of coffee accumulated inside the dosing device and not that dispensed into the filter-holder cup. It is specifically pointed out that the cell is integrated in the upper part of the body, being connected to the dosing device and not in the base, with different purposes and means, where the structural connections, the means for housing and fixing it, the means for transferring and detecting the load and the means for reducing vibration, are necessarily different.

Fourthly, it has been found that when the weighing device is integrated close to the motor and/or the grindstones, increased vibrations and calibration alterations can be detected, compromising the effectiveness of operation. It is therefore preferred to integrate the load cell inside the machine body as far as possible from vibration sources. Furthermore, in known solutions such as the D7, the cell is integrated in an uncomfortable location for maintenance and replacement, with multiple elements in between.

Fifthly, it has been found that generic dumpening supports made of a resilient and/or elastic material absorb shocks and vibrations uniformly or in one direction only, but do not allow for a floating, i.e. suspended effect so that vibrations and shocks are absorbed from all directions. Furthermore, combined systems of absorption and calibrated subsidence, depending on a maximum tolerable load, are not known and are desirable. Known cell protection systems are expensive, complex to implement and sometimes ineffective.

In particular, the problem of protecting a modern, highly sensitive load cell from accidental shocks or excessive loads that exceed its maximum tolerable value, damaging it, is well known. In particular, this problem occurs in the case of accidental bumps to a support fork structurally connected to the cell, when using conventional bar filter-holder cups for espresso machines, which are made of metal and of high weight. It has been observed, in fact, that known protection solutions with blocking systems or end stops in the stroke of the cell, as in D2 and D3, require extreme precision in terms of construction, since this stroke is extremely reduced, generally equal to fractions of a millimetre, and therefore not suitable for equipment with high vibrations and with construction elements subject to couplings and/or moulding tolerances and/or thermal expansion inadequate for the precision required for this purpose.

These disadvantages are even greater in protection systems with subsidence of the cup support, as for example in D1, where the construction elements involved have larger dimensions, with greater construction tolerances, thermal expansion and coupling problems; there is also the problem of the direction of the shock or stress that determines the detachment, since a cross direction is generally disadvantaged with respect to the direction of insertion or coupling, with a possible delay in the subsidence of the support. It is therefore preferred to have a cell protection system where the subsidence of the support is independent of geometric and/or construction and/or coupling and/or temperature constraints. In addition, in element retaining solutions with magnets, as in D1, it is known that the retaining force tends to decrease with time, making the protection system ineffective.

In general, known solutions are not adequate for the needs of a modern professional activity. In particular, any inaccurate readings and/or calibration alteration and/or damage of the cell integrated in the grinder-doser appliance are difficult to detect by the operator, so frequent checks and adjustments of the appliance are necessary; however, maintenance is expensive, complex in execution, and requires considerable attention and operator skills. In addition, known vibration absorption solutions do not sufficiently reduce overall noise.

In conclusion, an electronic coffee grinder-doser appliance of the grind-by-weight type, for espresso cups, which dispenses the desired quantity with maximum precision and repeatability and also protects the cell, while limiting vibration and noise more during ordinary operation, is not known and is widely desirable in the professional field. All this considered, it is reasonable the need for companies in the field to find innovative solutions and be able to overcome at least the above noted problems.

### SUMMARY OF THE INVENTION

These and other purposes, are achieved by the present invention according to the appended claims, by solving the problems set forth by means of a real-time weight-controlled automatic coffee grinder-doser appliance (10) comprising a machine body (100) having a shell and a base, motor-driven grinding means, a dispenser, a support fork for filter-holder cup, a load cell (112) mounted on the base and connected to the fork, a logic unit that stops the drive at a preset value. The appliance (10) has a first absorber device (120) that isolates the cell from the base, with a mounting plate (121) provided with protrusions as point supports, a housing seat for attaching the cantilevered cell, and floating fixings (122) to join the plate to the base by decoupling the elements and absorbing vibrations in each direction. The machine body is also provided with a second absorber device (140), with opposing anti-vibration elements (141, 142) that preventively limit the transmission of shock and vibration to the base.

### Purposes

Thus, through the considerable creative input, the effect of which constitutes an immediate and not irrelevant technical progress, several remarkable purposes are achieved.

A first purpose was to make a modern coffee grinding and dosing appliance of the automatic real-time weight-controlled type, or grind by weight, which is suitable for professional use since it is equipped with a highly sensitive electronic weight detection device and a powerful motor, and is able to effectively limit the well-known disturbances caused by vibration. In particular, innovative damping means are proposed that effectively reduce the transmission of vibration to the cell under any conditions of use, with higher weighing accuracy and cell protection, and also with lower overall vibration and less noise.

A second purpose was to isolate in a floating or suspended manner a modern electronic load cell weight detection device, which is mounted on the base inside the appliance in such a way as to absorb shocks and vibrations from any direction, ensuring the highest quality of detection under all conditions of use. Contextually, one purpose has also been to protect the said detection device from excessive shocks or loads, keeping it in the correct operating position when the loads are below the maximum tolerable value of the cell and safely repositioning it when they reach that value, with a possible margin of tolerance. In practice, it is intended to realize an optimized system of shock-absorbing, damping and protective support, with a floating effect combined with a calibrated subsidence according to the maximum load capacity of the cell, so as to overcome the constructive and functional limitations of the well-known protection systems with block or end stops.

A fourth purpose was to preventively reduce the transmission of shocks and vibrations to the cell and between the rigid elements of the machine body and the cell, particularly by isolating the base by means of fixings built into point, insulated, and shock-absorbing supports.

Essentially, an optimized absorption system is intended for grind-by-weight type appliances, in order to absorb the continuous stresses on the cell in such a way as to ensure reliable detections at all times, and also to protect it from excessive loads or accidental shocks. In fact, the proposed absorption system is particularly suitable in cases where the filter-holder cup is directly connected to a free end of the cell. Contextually, the transmission of vibrations and shocks from the work surface and the body or vice versa is eliminated by means of isolated fixings from above and below, where the elements are joined but structurally decoupled.

A further advantage, consequent to the previous purposes, was to limit the overall vibration of the appliance and the noise caused by it, making an operator's practical work more comfortable and easier. In addition, wear of mechanical parts is limited and malfunctions of electronic means of control and command are reduced.

Overall, an effective shock and vibration absorption system with good technological content is proposed; the invention, moreover, is economical and can be produced in high quantities by modern industrial processes.

These and other advantages will be apparent from the following detailed description of a preferred embodiment with the help of the attached drawings.

### CONTENTS OF THE DRAWINGS

FIG. 1 is a front representation of the coffee grinder-doser appliance of the automatic real-time weight control type, otherwise called grind by weight, as provided in this invention.

FIG. 2 is a sectional view of the machine body referred to in the appliance of FIG. 1, at the vertical plane of section X1-X1.

FIG. 3 depicts an enlarged detail of the first absorber device applied to the load cell, referred to the circle highlighted in FIG. 2.

FIG. 4 depicts an enlarged detail of a floating attachment in the said first absorber, referred to the dashed circle in FIG. 3.

FIG. 5 is a cross-sectional view of the machine body referred to in FIG. 2, at the horizontal plane of section X2-X2.

FIG. 6 is a sectional view of the base in partial section, including the first absorber device and the second absorber device, at the vertical plane of section X3-X3 in FIG. 5.

FIG. 7 is an axonometric view of said machine body, with the body partially sectioned to highlight the internal elements.

FIG. 8 is an axonometric detail view of the first absorber device, partially sectioned, referred to in FIG. 3 and the rectangle highlighted in FIG. 7.

FIG. 9 is an axonometric detail view of the floating fixing, partially sectioned, referred to in FIG. 4 and the circle highlighted in FIG. 8.

FIG. 10 is an axonometric view of said machine body, with the shell partially sectioned to highlight the cap of the first absorber device.

FIG. 11 is an exploded axonometric view of the front bulkhead joined to the cell connection bracket, with adjustable fork.

FIG. 12 is an exploded axonometric view of the base highlighting the first absorber device including cell and bracket, and the second device including the lower insulating foot and upper insulating counter-foot.

FIG. 13 is an exploded detail sectional view of the second absorber device.

### PRACTICAL EXECUTION OF THE INVENTION

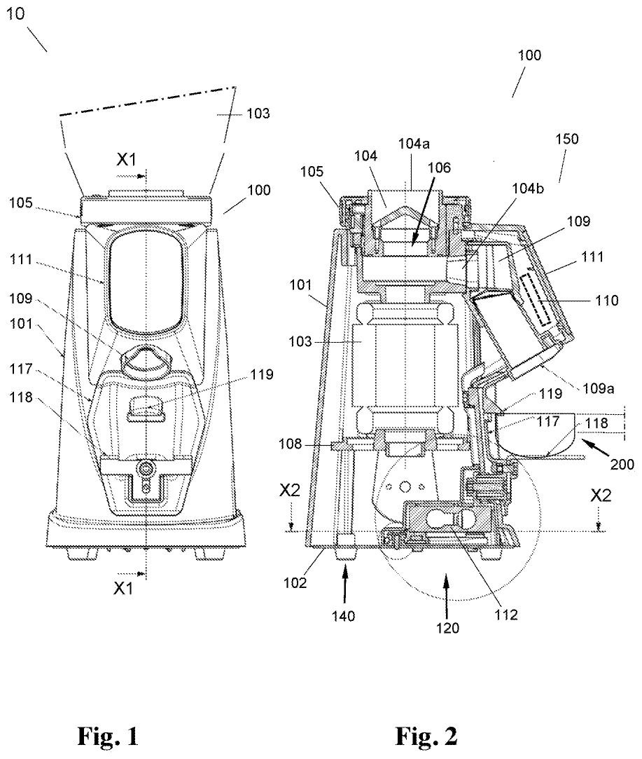

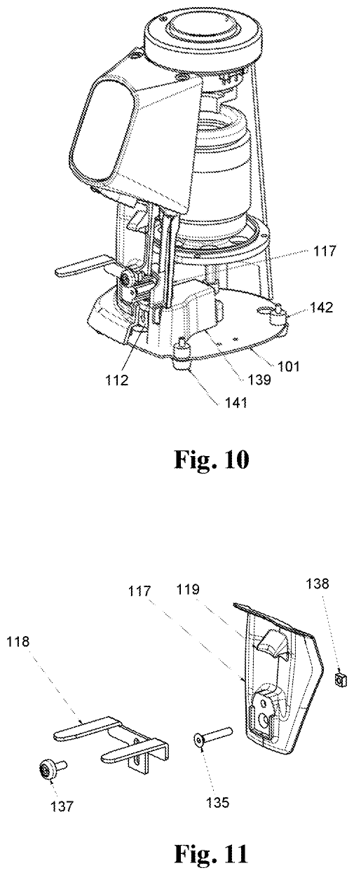

With also reference to the drawings (FIGS. 1-13), briefly, the proposed invention refers to a real-time weight-controlled coffee grinder-doser appliance (10), otherwise called grind by weight in English, of the improved type with anti-vibration means, which is suitable to grind and dose coffee beans automatically and with high precision by dispensing the ground product frontally. The proposed appliance is particularly suitable for professional use in bars and restaurants to continuously dispense the desired dose into a filter-holder cup (200) for espresso coffee. For the purposes of the invention, the appliance incorporates in the machine body (100) a weighing device optimized to eliminate the well-known problems caused by shock and vibration, where an electronic load cell (112) is mounted on a damping structure, with a floating effect and calibrated subsidence, which is conventionally called the first absorbing device (120). Additionally, the machine body (100) has the shell (101) and a base (102) joined at insulated fixings that integrate a shock-absorbing system, with decoupling effect, which is conventionally called the second absorbing device (140). The following technical description does not highlight certain conventional and known constructional elements, which are nevertheless included in the device such as, for example, the wiring, transformer, or mechanical fixings.

The grinder-doser appliance (10) is of the type consisting of a machine body (100) including a rigid shell (101) and a rigid base (102), joined together, with support feet mounted under said base and facing the work surface (201). Inside the machine body, at the top of the shell, there is a grinding chamber (104) with an inlet opening (104a) of the whole beans and a front outlet opening (104b) for the ground powder. A container (103) of whole beans is then mounted on the machine body; for example, it is a transparent inverted cone inserted at said inlet opening, to feed the beans into it preferably by gravity. In the grinding chamber (104) there are means for rotary grinding of the beans such as, for example, a pair of opposing grindstones (106) one movable grindstone and one fixed, mounted on a grinding adjustment ring (105) to vary the distance between them. At least one grindstone is connected to an electric motor (107) integrated within the shell (101) below the grinding chamber, which is attached to a support (108) structurally joined to said shell. The appliance then includes a dispensing group (109) connected to the outlet opening from the grinding chamber and provided with a front discharge tube (109a) to dispense the ground powder outside the machine body (FIGS. 1, 2). Combined with said dispensing means are means for frontally constraining a collection container, below said discharge tube; in particular, there is a fork (118, 119) for centering and supporting a filter-holder cup (200) for espresso coffee, preferably of the type used in bars in conjunction with common espresso machines that consist of a metal cup containing a filter for one or two cups, which is joined to a horizontal handle.

Within the machine body (100) there are some electronic devices that allow the automatic operation of the appliance; in particular, there is included at least one load cell (112), mounted on the base (102), which detects in real time the amount of powder ground and actually dispensed. In addition, there are electronic means of control and command, with at least one internal logic unit (110) which is equipped with operating programs and a user interface display (111) that is visible and accessible from the front of the appliance (150); they (110, 111) are then connected to each other, to the motor (107) and to the cell (112) in such a way as to stop the motor drive at a preset value as the desired dose (FIG. 2) or weight.

The grinder-doser appliance (10) is provided with a first absorber device (120) that is applied to said load cell (112), being mounted on the base (102, 130) in such a way as to interpose itself between the cell and the supporting structure of the appliance, effectively reducing the transmission of vibrations and consequently improving the accuracy and reliability of the detection in real time, with active motor, with also greater safety and protection from shocks and/or excessive loads (FIGS. 2, 3, 5). The said cell (112), in fact, detects the weight of the ground powder that progressively accumulates in the filter-holder cup (200), having the free end (114) joined to a bracket (116) that acts as a connection between the inside and the outside of the appliance, on which a rigid front bulkhead (117) including the said fork (118) is fixed. The weight of the ground and dispensed powder is then transferred to the load cell to be detected (110, 111) in real time with accuracy and safety even during grinding.

In detail from a construction point of view, the aforementioned first absorber device (120) is a composite damping structure (121, 122) designed to attach the cell (112) to the base (102) and significantly reduce the transmission of vibration and/or shock and/or excessive loads (100, 101, 102, 107, 114, 118, 200, 201) to the said cell (112), comprising a mounting plate (121) and combined attachment and absorption means, with a floating effect, which are conventionally called floating fixings (122).

Said mounting plate (121) is three-dimensionally shaped with holed protrusions (123, 124) extending downward as point supports on the base (102, 122, 130) and with the remaining portions of the plate (125) raised from it (102) to isolate said supports and allow for the floating absorption intended by the invention. The plate (121) includes a housing seat (126) holed to secure with screws (115) one end of the cell (113), leaving the opposite end (114) cantilevered horizontally to flex under load, in the operating position, being connected to the fork (118) for centering and supporting the cup (200) by means of rigid elements that transfer the entire weight of the coffee dispensed. In the preferred configuration, these elements are a connecting bracket (116) attached to the cell (114) combined with a molded, rigid front bulkhead (117) that simultaneously acts as a structural connection and shielding for the shell crossing opening (FIGS. 2, 3, 8, 11, 12). The said cell housing (126) and fixing seat is external to the protrusions (123), i.e., being integrated into the remaining portions of the plate (125) and raised from the base to position the cantilevered cell parallel to it. Any residual vibrations are then spread and dissipated over the entire mounting plate and multiple absorbing support points with a floating effect, external to said seat (126), further limiting the transmission of shock and vibration to the cell (112).

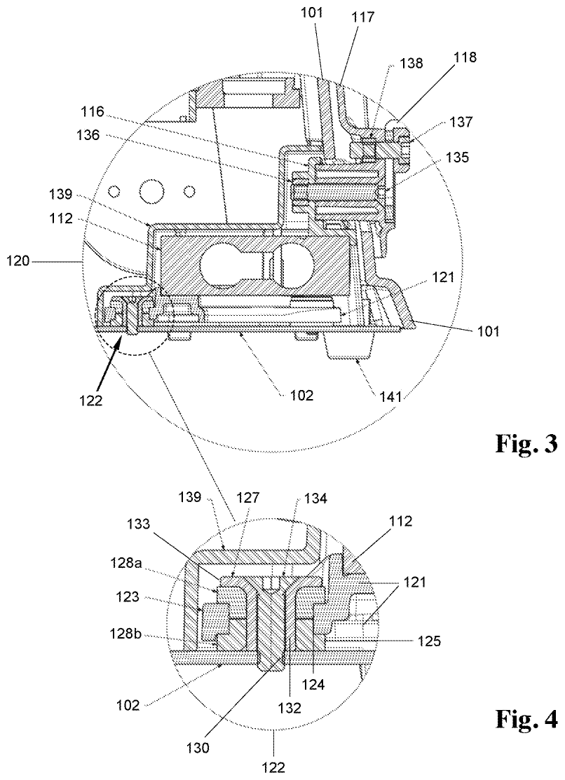

In the preferred but not exclusive embodiment (FIGS. 3, 8, 12), the mounting plate (121) has a V-shape conformation with three attachment points corresponding to as many protrusions (120, 123), positioned at the two ends and vertex of said V, and with the cell housing and attachment seat (115, 126) centrally integrated near the vertex, facing inward from said V. This configuration is advantageous for mounting on the base with screws (102, 129, 130) and for attaching the cell cantilevered toward the front of the appliance, with the end free to flex frontally (112, 114, 150). However, other plate configurations (121), not shown in the above drawings, are possible and advantageous, being, however, inclusive of the point supports on the base with floating fixings (102, 122, 123, 130) and a cell fixing seat (112, 126) to position the cell properly for detection purposes.

Said floating fixings (122) join the mounting plate (121) to the base (102) with structural decoupling and vibration absorption in each direction, with a suspended constraint effect otherwise referred to as floating; specifically, each holed protrusion (123) of the plate (121) has a single floating fixing (122) that individually comprises at least a pair of damping rings (128a, 128b) and a centering bushing (127) inserted in them, which are collectively (123, 124, 127, 128a, 128b) traversed by a through fixing screw (129) that engages a threaded hole (130) in the base, with the bushing in the abutment (127, 134). It is clear that in the proposed floating fixing, the pair of damping rings (128a, 128b), joined and compressed by means of the bushing and screw (127, 129), internally isolates the hole (124) and also the resting to the base such that there is always a resilient and/or elastic element interposed between the rigid structural elements that prevents their direct contact in any direction, and the consequent transmission of vibrations and/or shocks, it being of material, thickness, consistency and compression (129, 130, 134) suitable for said absorption.

The damping rings (128a, 128b) are made of a resilient and/or elastic and/or elastoplastic material, or a material with similar damping behavior, such as a rubber or silicone or silicone rubber or equivalent polymer, and have a double-diameter (D1, D2) construction configuration (FIGS. 8, 9, 12) to be inserted symmetrically into the same hole (124, S2), from above and below, resting on both edges (131a, 131b); once inserted, they combine in the guise of a single damping and insulating insert protruding above and below the plate (121, 122, S1), to isolate (S1, S2) both the plate and the hole (121, 124) from the direct contact of base, bushing, and screw (102, 127, 129) with a floating effect, with a suspension effect in each direction as occurs in flotation. Thus, it is clear that the term insulating is meant in the structural sense, referring to the transmission of vibration.

Additionally, in order to protect the cell (112) from excessive shocks and loads, these damping rings (128a, 128b) have a resilience and/or elasticity calibrated according to the maximum tolerable load of the same cell, considering also the contribution in compression of the fixing with said bushing and screw (127, 129), in the guise of a calibrated subsidence where each floating fixing (122) keeps the cell in the correct position in ordinary detection but subsides when the detected load exceeds said maximum tolerable load. In practice, in such cases of exceedance, the absorber device (120, 122) tilts or translates, automatically placing the cell in a safe position, e.g., lower, where the excess load is nullified and/or dissipated.

The centering bushing (127) includes a head (133) that is wide, with a diameter such that it compresses the upper ring (128a) and consequently the lower ring (128b); in particular, it has a stem (132) that has an abutment (134) at the base and is holed, to be traversed by the through-screw (129), such that it compresses said damping rings (128a, 128b) in a calibrated manner, as described above. Thus, the tightening of the screw is calibrated in combination with the said resilience and/or elasticity of the damping rings (128a, 128b). In practice, in each floating fixing (122), the elements must be shaped and calibrated from time to time in accordance with said elasticity and/or resilience of the material of the rings, in conjunction with said maximum load of the cell and tightening of the screw with a bushing in abutment, such that the cell (112) is maintained in an operative position when the loads (114) are less than said maximum tolerable load and instead such that it subsides when said maximum load is reached, repositioning the cell safely.

In the case of a high-precision load cell operating in the ordinary detection position with loads between 6 grams and 15 grams, according to the common single and double doses of espresso coffee, damping rings (128a, 128b, D1, D2) made of a rubber or silicone rubber or an equivalent resilient and/or elastic and/or elastoplastic polymer, of hardness between 40 Shore and 80 Shore, are suitable for achieving the above floating effect with calibrated subsidence. Particularly, a silicone rubber of, for example, 50 Shore is suitable for the invention. In such a case, these rings, when assembled and compressed with the bushing in the abutment (127, 129, 134) as set forth above, have the material interposed between protrusion and head (123, 132) and between protrusion and base (102, 123) of thickness (S1) equal to at least 0.5 mm; similarly, the material interposed between hole and screw (124, 129) is of thickness (S2) equal to at least 0.5 mm.

Preferably, a protective cap (139) is also included in said first absorber device (120), fixed on the mounting plate around the load cell (112) in such a way as to cover and protect it from the electrical cables that are inside the machine body and may hinder detection, and simultaneously such as to protect the cell from the electromagnetic fields of the electric motor; it also protects the cell from dust or other material suspended or falling inside the machine body, which may possibly damage it. In this way, the quality of detection is further guaranteed and is durable.

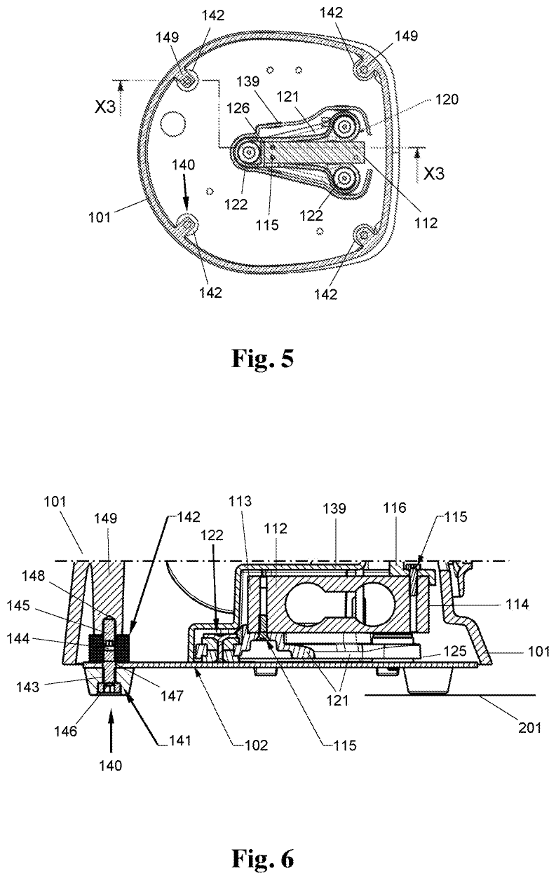

The aforementioned first absorber device (120) is a damping structure that eliminates and/or limits the transmission of shock and vibration from the base (102) to the load cell (112); in addition to it, in order to achieve greater absorption and protection effectiveness of the cell, it is contemplated to preventively limit the transmission of shocks and vibrations to the base (102), from above and below, by means of an innovative system of damping supports composed of dual and opposed anti-vibration elements acting in combination as an integrated absorption system, conventionally referred to as the second absorber device (140). Specifically, the shell (101) and the base (102) are joined together at insulated attachment points (147, 148, 149) where the aforementioned second absorber device (140) is integrated, which interposes an insulating means between the shell and the base advantageously opposed to and aligned with a support foot, also insulating, jointly mounted on the opposite side of the base (102, 147). In this way, each support point acts as a complex node with a decoupling effect between concurrent structural elements, above and below the base, so as to reduce the transmission of shock and vibration between the shell (101, 107, 108, 200) and the base (102, 112) and, concurrently, between it (102) and the work surface (201), and vice versa (FIGS. 5, 6).

Examining in detail the implementation of the second absorber device (140), it consists of a lower insulating support foot (141) coupled with an upper insulating counter-foot (142), both of which are made of a resilient and/or elastic material such as a rubber or silicone or silicone rubber or polymer equivalent; both are holed (143, 144) and aligned vertically, overlapping above (142) and below (141) the base (102), to be passed through and secured at the same hole (147) by means of a through screw (146) and a threaded grub screw (145). Notably, these two fixings (145, 146) are decoupled from each other by being inserted into the counter-foot (142, 144) without touching each other: the through-screw (146) passes through the holed foot and the base (141, 143, 147) to engage from the bottom upward in the counter-foot (142), at the lower portion of the hole (144). The counter-foot (142), on the other hand, is attached to the body by a threaded grub screw (145) that is inserted into the upper portion of the same hole (142) and protrudes upward to engage in a threaded seat (148) of the body (101). For ease of assembly, it is advantageous to secure the counter-foot in advance by screwing in said grub screw, and then attach the foot to the counter-foot by means of the through screw (FIGS. 6, 12, 13).

Preferably, the shell structure (101) is provided with supporting ribs (149) which are raised toward the inside of the machine body, leaving on the outside a thinner, continuous surface layer in the guise of a shaped shell. At the lower end of each rib is obtained the said threaded seat (148), while at the upper end is mounted the motor support (108), which then discharges vibrations mainly to the said insulating counter-foot (142), reducing the involvement of the other elements (FIGS. 2, 5, 6, 7).

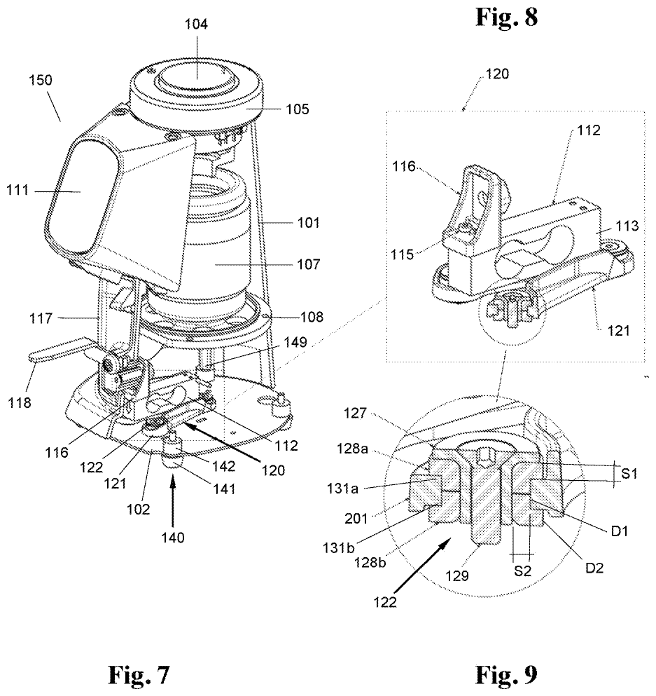

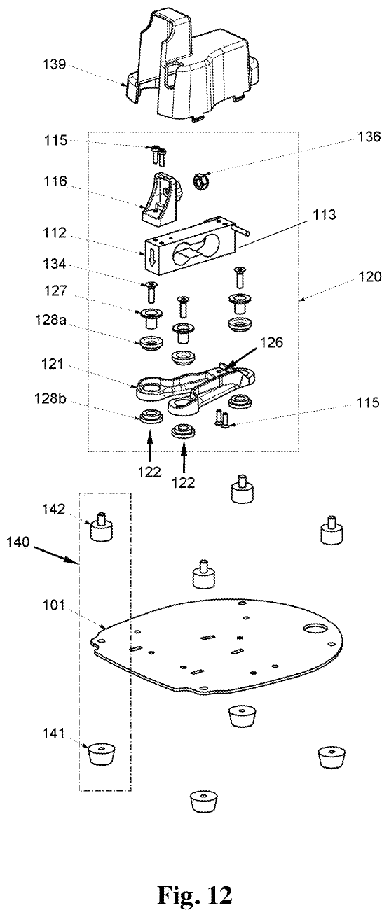

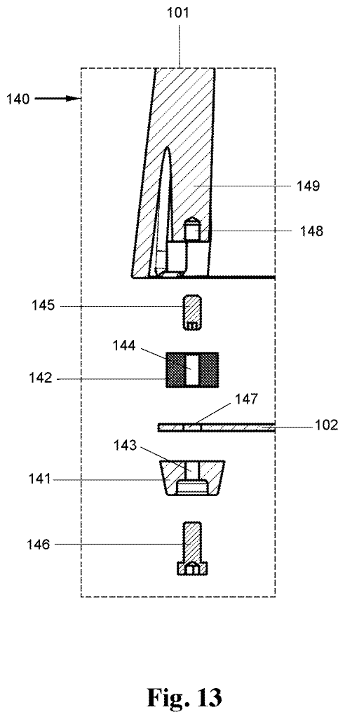

In an improved grinder-doser appliance (10) as described above, at least three insulated support and fixing points (147, 148) are provided, each integrating the said second absorber device (140) with insulated feet and counter-feet (141, 142); however, more insulated fixings can be provided. It was experimentally found, for the purposes of the invention, that four insulated fixings, each with said second absorbing device (140), are optimal (FIGS. 7, 12).

It is observed that this absorbing device (140) advantageously combines an external anti-vibration element of a known type mounted on the bottom face of the base, such as an insulating support foot (141), with an innovative internal anti-vibration element opposed to it, called an insulating counter-foot (142), which is mounted on the top face of the base with a decoupling and protective effect. Said foot and counter-foot are holed (143, 144) and aligned vertically on the same hole (130) of the base to be jointly joined to the shell (101, 148), where the counter-foot (142) interposes itself between the shell and the base in the guise of a structural discontinuity or decoupling. This increases the damping of vibrations and/or shocks transmitted from the machine body (100) to the work surface (201) and vice versa, and also damps internal shocks and vibrations between the body and the base where the cell (112) is mounted, which is thus more protected and isolated. By combining the said first absorber device (120), applied to the cell, with the said second absorber device (140) applied to each support, greater protection is guaranteed with high quality real-time detection.

It is also noted that, in principle, support feet made of rubber or other resilient and/or elastic material are considered conventional elements in motor-driven appliances where applied individually below the base or any basement to reduce the transmission of vibrations from the machine body to the work surface. However, an opposing pair of resilient and/or elastic elements, either external or internal to the machine body, which are combined according to the purposes of the invention in such a way as to create isolated resting and attachment points where the shell, base, and work surface join but are structurally decoupled, in the manner of an anti-vibration node, is unknown and advantageous. Compared with conventional antivibration solutions with only insulating feet, a pair of opposing elements also realizes more effective damping inside the machine body, where each fixing between the shell and base is aligned at the support foot, with an additional absorbing means interposed between the base and the shell; in fact, we should take into account that the body is a disturbing vibrating element in weight detection being integral to the motor support (108). Consequently, an appliance mounted on anti-vibration supports is made that isolate the base (102, 112) from below (141, 201) and above (107, 108, 142) in the guise of a suspended element.

For the purposes of the invention, by way of example, insulating feet (141) and insulating counter-feet (142) made of a rubber or silicone or silicone rubber or an equivalent resilient and/or elastic and/or elastoplastic polymer are particularly suitable; said materials, having, for example, a hardness between 40 Shore and 80 Shore. Particularly effective are insulating feet and counter-feet of cylindrical shape, other construction configurations, however, being suitable and possible.

In an embodiment variant considered equivalent for the purposes of the invention, which optimizes the support and insulation of the shell by facilitating the centering of the anti-vibration means, a cylindrical insulating counter-foot with a double diameter, centrally holed, which is also capable of insulating the base hole from the inside, is provided. It has a small-diameter cylindrical portion that protrudes below downward to be introduced into said hole, so as to cover its inner surface and completely separate the fixing element joining the shell to the underlying foot.

In order to facilitate assembly and balance the compression of the insulating material in the various holes, thereby optimizing overall vibration damping, the said double-diameter counter-foot can be associated with a cylindrical flanged bushing, of a known type, which is inserted from above into the same hole with the protrusion of the counter-foot always interposed between the bushing and the base. Advantageously, the said counter-foot can have a double-diameter and be symmetrical, with respect to the portion inserted in the bore of the base, so as to make an interlocking coupling above and below, with greater stability. It has been found that in case of this configuration of composite counter-foot with bushing, it is particularly advantageous to combine it with a rubber foot that centrally integrates a threaded metal insert, of the known type, which centrally crosses from below upward said counter-foot and bushing, in said hole, to anchor itself directly to the shell by compressing the counter-foot in a packet fashion at least on the bottom and inside the hole, filling the cavity with insulating material. Anti-vibration and filling elements, made of rubber or a similar material, are then interposed between the base and the bushings; in practice, with this solution, the base cannot touch the bushings and a complete insulation of the shell is ensured, damping the vibrations of the motor even in the horizontal direction.

It is therefore observed, in the practical use of the appliance (10), that the said absorber devices (140) realize isolated supports with structural decoupling (101, 102, 142) that significantly reduce the internal vibrations on the base (102, 112) during motor drive, to optimize real-time weight detection, and also limit the overall vibrations of the appliance and the work surface. As a result, the overall noise of the appliance is reduced. It was experimentally found, as an example, that integrating four supports, each with an absorbing device (140), results in a reduction of the said overall noise by about 4 dB, which corresponds to a percentage value of about 5%. Such a noise reduction is considered to be significant from a technical point of view and can be perceived by operators and customers. Finally, it has been found that the invention facilitates professional activity; in fact, the physical and mental fatigue of an operator is reduced and at the same time the quality of the service provided is improved.

### LEGEND

(10) coffee bean grinder-doser appliance, of the automatic real-time weight control type otherwise referred to as grind by weight, as provided in this invention;
(100) machine body;
(101) shell;
(102) base;
(103) cone-shaped container of whole roasted coffee beans;
(104) grinding chamber, with an inlet opening for whole beans (104a) and an outlet opening for ground powder (104b);
(105) grinding adjustment ring;
(106) grindstones, such as a moving grindstone and a fixed grindstone;
(107) electric motor;
(108) motor support, integral to the body;
(109) dispensing unit, with chute ducts and front discharge pipe (109a);
(110) internal logic unit, equipped with operating programs;
(111) user interface display;
(112) load cell, mounted on the base;
(113) end of the cell to be fixed on the mounting plate;
(114) cantilevered cell end, to flex under load;
(115) cell fixing screw;
(116) fixing and connecting bracket, inside the shell;
(117) shaped front bulkhead, rigid shielding structure, filter-holder cup attachment connection;
(118) centering fork and filter-holder cup support;
(119) filter-holder cup attachment element;
(120) first absorber device, applied to the load cell with a protective function and for detection accuracy, such as a composite damping structure on insulated supports, of the floating, anti-vibration and anti-shock type;
(121) three-dimensionally shaped cell mounting plate;
(122) floating fixing;
(123) protrusions, facing the base as point supports;
(124) through-hole fixing the plate;
(125) portions of plate between protrusions, external to them and raised from the base;
(126) housing and fixing seat of load cell;
(127) holed centering and compression bushing;
(128a, 128b) damping rings;
(129) fixing through screw, engaged to the base;
(130) threaded hole in the base;
(131a, 131b) opposite edges of hole, upper (131a) and lower (131b) respectively;
(132) bushing stem, longitudinally holed;
(133) bushing head, flat and wide.
(134) through screw for fixing the first absorber device;
(135) bulkhead fixing screw;
(136) bulkhead fixing nut;
(137) fork fixing and adjusting screw;
(138) fork fixing nut;
(139) protection cap and load cell insulation;
(140) second absorbing device, anti-vibration support of the combined and decoupling type for shell, base and work surface;
(141) insulating support foot, lower anti-vibration element;
(142) insulating counter-foot, upper anti-vibration element;
(143) foot hole;
(144) counter-foot hole;
(145) threaded grub screw, counter-foot insert for fixing the shell;
(146) foot fixing screw;
(147) foot hole, for foot and counter-foot;
(148) threaded seat of the shell, for counter-foot fixing;
(149) insulated support rib of the shell on the counter-foot;
(150) front of the appliance;
(200) espresso filter-holder cup;
(201) work surface;
(D1, D2) double diameter of the damping ring, larger (D1) and smaller (D2) respectively;
(S1, S2) thickness of the damping ring, raised on the resting surface, respectively on the plate (S1) and inside the hole (S2).

1. (canceled)

2. (canceled)

3. (canceled)

4. (canceled)

5. (canceled)

6. (canceled)

7. (canceled)

8. (canceled)

9. (canceled)

10. (canceled)

11. Grinder-doser appliance for coffee beans, of the automatic type with real-time weight control or grind by weight, comprising:
a machine body, with a shell and a base joined together, and support feet mounted under the base;
a grinding chamber inside the machine body, with an inlet opening for the beans and an outlet opening for the ground powder;
a container for the beans mounted on the shell at said inlet opening;
means for rotationally grinding the beans in the grinding chamber, such as grinding elements mounted on an adjustment ring;
means for operating said grinding elements, such as an electric motor mounted on a support inside the shell and integral with it;
means for dispensing the ground powder, such as a dispensing group connected to said outlet opening and provided with a front discharge tube;
means for constraining a collection container under said discharge tube, being a fork for centering and supporting the filter-holder cup;
means for weighing in real time the ground and distributed coffee, which are inside the machine body, being a load cell mounted on the base and connected to said fork;
electronic control and command means, with at least one internal logic control unit provided with operative programs and one user interface display on the front of the appliance, said means being connected to each other, to the motor and to the cell in order to block the operation of the motor at a pre-set value corresponding to the desired dose;
means for reducing the vibrations caused by the motor;
wherein said means for reducing the vibrations have a first absorbing device which is interposed between said base and said cell; and
wherein said first absorber device is a damping composite structure for fixing the cell to the base in a floating way, said cell being isolated from the base, comprising:
a mounting plate of the cell, provided with holed protrusions extending downwards like specific supports on the base and with a housing seat outside said protrusions for fixing an end of the cell leaving the opposite end cantilevered, lifted from the base in operative position, being connected to the fork with rigid elements internally transferring the weight of the dispensed coffee; and
floating fixings joining said plate to the base decoupling the rigid elements and absorbing vibrations in every direction, with a floating fixing for each holed protrusion.

12. The grinder-doser appliance of claim 11, wherein a single floating fixing includes a couple of damping rings made of a resilient and/or elastic material and a centering bushing which is inserted therein and compresses them, each being passed through by a through screw engaging in a threaded hole of the base; said damping rings, both of them with double diameter for being symmetrically inserted in the same hole leaning on both the edges, protruding from above and below in order to separate and isolate said protrusion from the base and from the bushing, with a floating effect of the first absorbing device.

13. The grinder-doser appliance of claim 12, wherein the centering bushing has a head having such a diameter to compresses the damping rings, with a holed stem passed through by a through screw and has an abutment at the base; said damping rings, made of a material having resilience and/or elasticity calibrated according to the maximum tolerable load of the cell and is compressed in a calibrated way by the bushing and by the screw in such a way as to keep the cell in operative position when the loads are lower than the maximum value tolerated by it, and instead it is such to subside and to securely reposition the cell when they reach it, considering a possible tolerance margin, with an effect of calibrated subsidence of the first absorbing device.

14. The grinder-doser appliance of claim 11, wherein said first absorbing device includes a shield for protecting and isolating the load cell from electromagnetic fields, which is fixed on the mounting plate around the cell.

15. The grinder-doser appliance of claim 11, wherein said means for the reduction of vibrations have a second absorbing device integrated in correspondence with each support foot, wherein the shell joins the base and the foot in a hole of the base, as a point of support and isolated decoupling fixing; said second absorbing device, made of an insulating support foot combined with an insulating counter-foot, both of them made of a resilient and/or elastic material and constrained to the same hole, respectively under and above it.

16. The grinder-doser appliance of claim 15, wherein said foot and said counter-foot are both holed for being fixed by a through screw and a threaded grub screw aligned and spaced one another, as a discontinuous fixing element; and where said through screw passes through the foot and the base from below to engage in the hole of the counter-foot, whereas the threaded grub screw is inserted in the upper portion of the same hole and protrudes upwards for engaging in one threaded seat in the shell; said second absorber device, isolating the base from vibrations and/or shocks transmitted by the shell and/or by the work surface and vice versa.

17. The grinder-doser appliance of claim 16, wherein said threaded seat is obtained in the lower end of one support rib which is in relief inside the shell, on which the motor support is also mounted.

18. The grinder-doser appliance of claim 12, wherein said damping rings are made of rubber or silicone or silicone rubber or an equally resilient and/or elastic and/or elastoplastic polymer with hardness between 40 Shore and 80 Shore.

19. The grinder-doser appliance of claim 18, wherein said damping rings have material between the protrusion and the head and between the protrusion and the base with a thickness of at least 0.5 mm, and the material between hole and screw with a thickness of at least 0.5 mm.

20. The grinder-doser appliance of claim 15, wherein said isolating feet and/or said isolating counter-feet are made of rubber or of silicone or silicone rubber or of an equally resilient and/or elastic and/or elastoplastic polymer with hardness between 40 Shore and 80 Shore.
